(19) United States
(12) Patent Application Publication
(10) Pub. No.: US 2007/0056427 A1
(43) Pub. Date: Mar. 15, 2007

(54) Midcut reciprocating blade

(76) Inventor: William Edward Males, Dunnellon, FL (US)

Correspondence Address: William E. Males, 12450 SE 118 Lane, Dunnellon, FL, 34431, US

(21) Appl. No.: 11/227,896

(22) Filed: Sep. 15, 2005

(51) Int. Cl. B23D 57/00

(52) U.S. Cl. 83/835; 83/846

(57) ABSTRACT

An improvement to the reciprocating saw blade's tip comprising of a arched/radial tip with either teeth or an abrasive grip coating on its cutting edge, allowing the penetration of most materials at a mid-surface point independent of the edges of the surface, utilizing the forward and backstroke of the reciprocating sawing action to its fullest cutting potential upon initial impact. The arched/radial tip maximizes control, extends durability, and increases the efficiency of the blade, accelerating the penetration of the cut, thus saving time, effort, and money.

### A. CROSS-REFERENCE TO RELATED APPLICATIONS

Not Applicable.

### B. FEDERALLY SPONSORED RESEARCH OR DEVELOPMENT

Not Applicable.

### C. SEQUENCE LISTING, A TABLE, OR A COMPUTER PROGRAM LISTING COMPACT DISC APPENDIX

Not Applicable.

### D. BACKGROUND OF THE INVENTION

1. The present invention relates to general purpose reciprocating blades, specifically to an improvement to the design of the tip of the typical blade, virtually eliminating the prior art's deflection of the blade over the cutting surface as it attempts to jam through it, minimizing wear and breakage of the blade, and reducing waste of time and money.

2. Whenever the opportunity arises where a cut has to be initiated away from the edges of a surface, whether at an internal point of one plane or at an inside angular intersection of two or more planes, the only blade available is the standard reciprocal general purpose reciprocal saw blade. This existing saw blade has a straightedge sawing edge parallel to one surface plane and a tip or nose created by a sharp angle projected up and behind the nose at an angle less than 90 degrees to meet the opposite edge of the blade. There are several flaws to the design of this widely used prior art.

3. The most obvious flaw of the prior art is that it comes to a tip or nose at the end of the sawing edge opposite to the end that attaches to the saw's motor. Whether the blade's nose is at a 90° or 10° angle to the sawing edge, the nose will always have to jam and dig into the surface before the sawing edge can begin to cut, delaying it's contribution to any sawing until the tip batters and chisels into enough of the material to engage the teeth or abrasive grit coating.

4. Another flaw is the lack of control the prior art's design generates. As the nose of the typical reciprocal blade attempts to penetrate through the surface on the forward stroke, it catches on the surface, ricochets the blade to and fro on the backstroke, and deflects the nose on the next forward stroke, causing the blade to ricochet wildly over the surface as much as two inches in any direction from the desired point of penetration. It takes considerable effort to stabilize the blade while the nose batters chisels and splinters its way through the surface using solely the forward stroke. The blade needs to dig deep enough into the surface before the backstroke begins to saw and stabilize the blade. This hindrance to control of the blade while cutting wastes much time, which leads to loss of efficiency, money and needless damage to the material.

5. An additional flaw in the prior art is t, as the nose of the prior art jams and catches the surface, it causes a destructive S-bend to the blade compromising its integrity and strength. The deflection and skipping across the surface progressively increases the damaging bends to the blade, forcing the operator to repeatedly stop the saw to straighten the bent blade and to start the saw in numerous attempts to return to the desired point of penetration. Consequently, the blade breaks at the bend, increasing overhead costs and waste of time. Whether a job has a deadline or not, it is imperative that the blades used at the site are fast reliable, efficient, and durable. The improvement to the design to the tip of the reciprocating blade has proven superior in all these areas.

6. The tip design of the present invention incorporates an arch up and beyond the straightedge sawing edge of the blade, facilitating a mid-surface interior, and bi-directional penetration into one plane as well as into multi-plane internal angular intersections. This design allows the radial sawing edge to begin cutting immediately upon impact and to saw more concertedly with minimal deflection, chiseling or splintering, thus improving the control, speed, efficiency and durability of the blade, saving time, effort and money. Since the only change is to the tip design of the existing reciprocating blade, fabricating the blade will take minimal adjustment to manufacturers' templates. The initial prototype proved that the modification to the blade tip is undemanding since the design improvement is a forward cutting arch enabling the blade to slide across the surface ensuing immediate bi-directional cutting strokes. Fabricating the blade will take minimal adjustment to manufacturers' templates.

7. Whether a smooth or rough cut is desired with the optional selection of either teeth configuration or abrasive grit coating, the arched/radial tip to the present invention will permit a quick penetrate all types of surfaces at any mid-surface point, efficiently rough-cutting through a wall at a construction site, piercing through the hot metal of a burning car, or cleanly cutting through a marble counter top.

### E. SUMMARY OF THE INVENTION

8. Instead of coming to a restrictive point at the end of the straightedge sawing edge, the design of the present invention arches the tip of the blade upward and beyond the cutting plane, thus maximizing from initial impact the blade's reciprocating strokes when the cut needed cannot utilize the outside edges of the plane, and enhancing speed, control, efficiency and durability of the blade.

### F. DESCRIPTION OF SEVERAL VIEWS OF THE DRAWINGS

FIG. 1 shows prior art's standard chisel-nose Ref. 1 reciprocal blade. Ref. 2 shows the standard straight sawing edge.

FIG. 2-a to 2-f show the sequence of deflective strikes of the prior art's chisel-nose design. Ref. 3, 4 show the deflective skipping, chiseling strikes of the forward strokes of the blade. Ref. 5 is the unproductive backstroke of the blade.

FIG. 3-a to 3-k show various aspects of the prior art design's deflection over surface of material as it batters into the surface of the material. FIG. 3-1 shows the destructive S-shape bend to the blade the chiseling causes, weakening the blade. Ref. 6 shows the most common breaking point. Ref. 7 shows most common change of directional bend areas on the bent blade.

FIG. 4 shows the improved blade design's side view with the arched/radial sawing tip Ref. 8.

FIG. 5 shows a perspective view of the improved blade design with the arched/curve cutting tip Ref. 8.

FIG. 6-a to 6-f show the improved blade design's immediate cutting action, utilizing both the forward stroke Ref. 9 and the backstroke Ref. 10.

FIG. 7 shows the straightedge Ref. 2, arched/radial cutting edge Ref. 8 with teeth, and the center point and radius Ref. 11 extending to the cutting point of the teeth.

FIG. 8 shows the straightedge Ref. 2, arched/radial cutting edge Ref. 8 with abrasive grit coating, and the center point and radius Ref. 11 extending to the cutting edge.

FIG. 9 shows jigsaw applications of the arched/curve cutting tip: the fastcut (left) and flushcut (right).

### G. DETAILED DESCRIPTION OF INVENTION

FIGS. 1, 2 and 3—Defects with Prior Art

9. FIG. 1. The design of the prior art has a straight sawing edge parallel to the surface plane Ref. 2 and a tip or nose created by a sharp angle projected up and away to meet the opposite edge of the blade Ref 1. The projection of the angle may be at various degrees, but all will form a nose at the end of the sawing edge requiring the blade to batter a hole before the sawing edge engages.

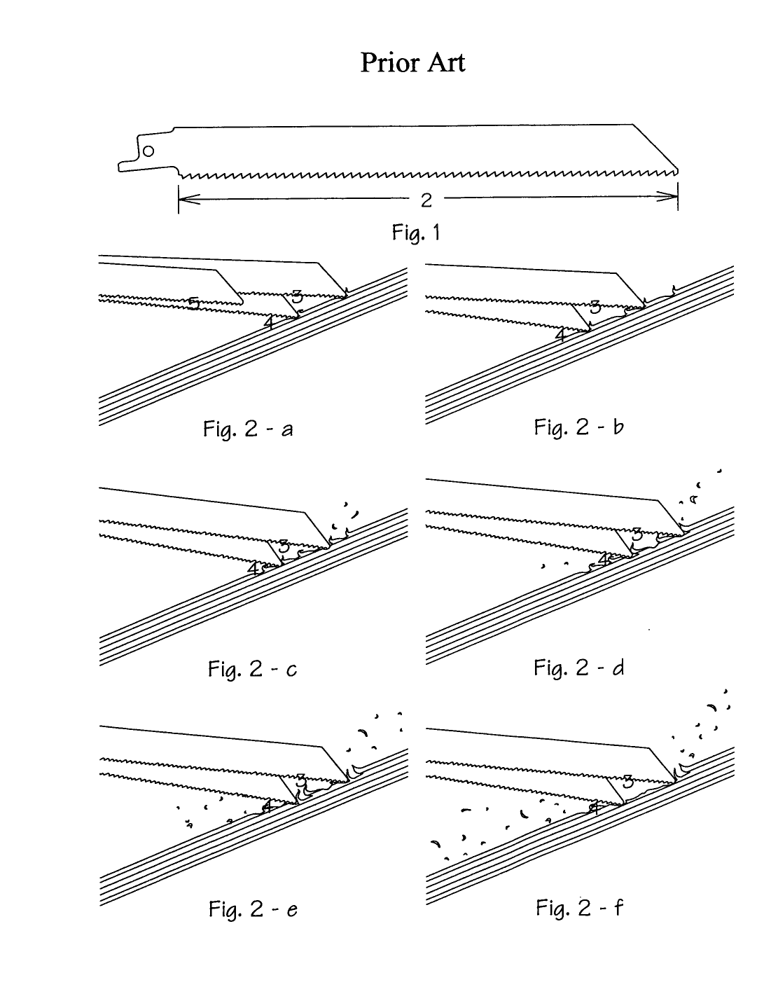

10. The prior art's chisel-nose design requires the continual battering of the surface FIG. 2-a. As the blade strikes the surface of the material, it jams and digs into it at various locations, Ref. 3, 4. The backstroke of the reciprocating action Ref. 5 is non-functional and unproductive since it is in the air and makes no contact with the surface until the chisel-nose tip digs deep enough for the straight sawing edge to engage the surface.

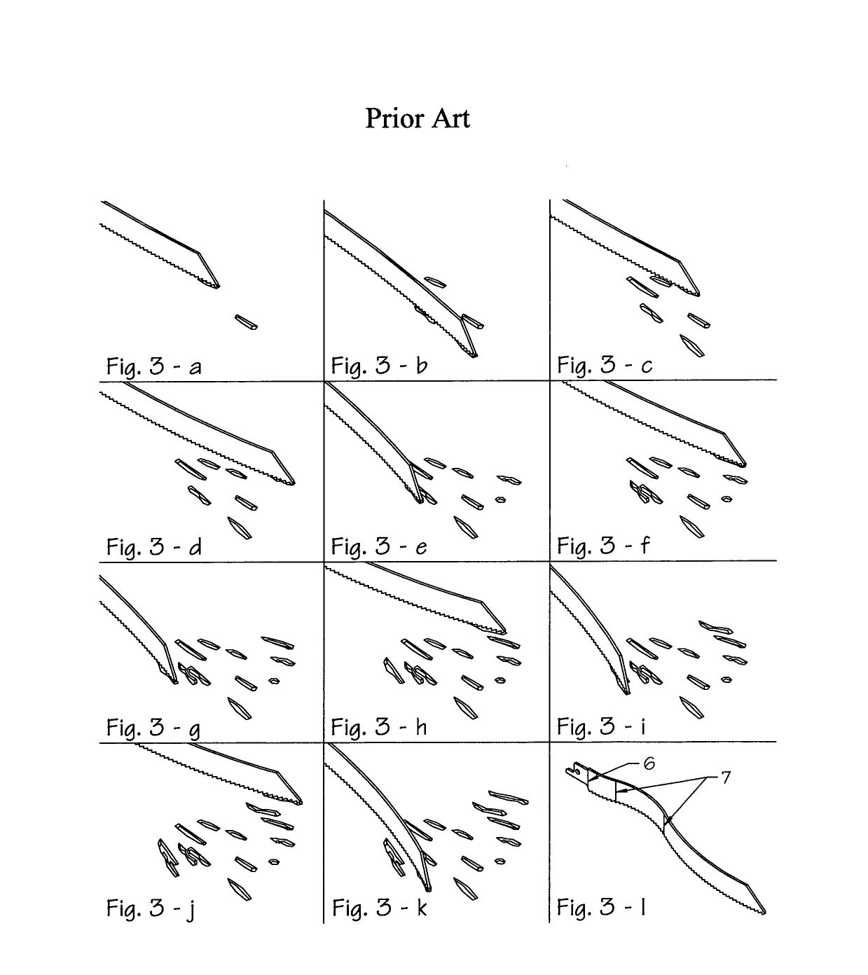

11. As the nose of the blade strikes and batters the surface, the blade ricochets wildly in the air causing the nose of the blade to ricochet wildly across the surface of the material as much as two inches in any direction from the desired point of penetration 3-a to k. The lack of control of the blade's movement and the erratic nature the nose's strikes the surface contributes to inefficiency and frustration. The continual jamming into the surface weakness and compromises the integrity and strength of the blade, creating an “S” shape bend to the blade FIG. 3-1. The operator has to stop the saw to manually re-straighten the blade to get the most use out of it, and start the saw again, repeatedly repositioning the blade at the desired point of penetration. Eventually, the blade brakes, leaving a mangled surface and resulting in loss of time, efficiency, and money.

FIGS. 4, 5, 6, 7, 8 and 9—Embodiment

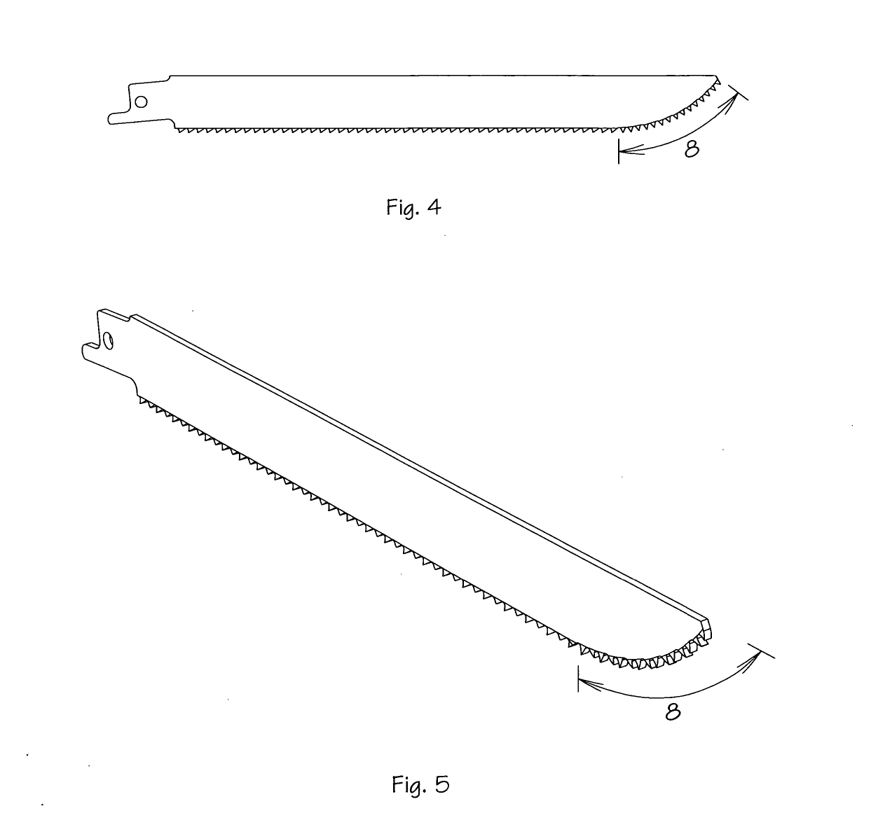

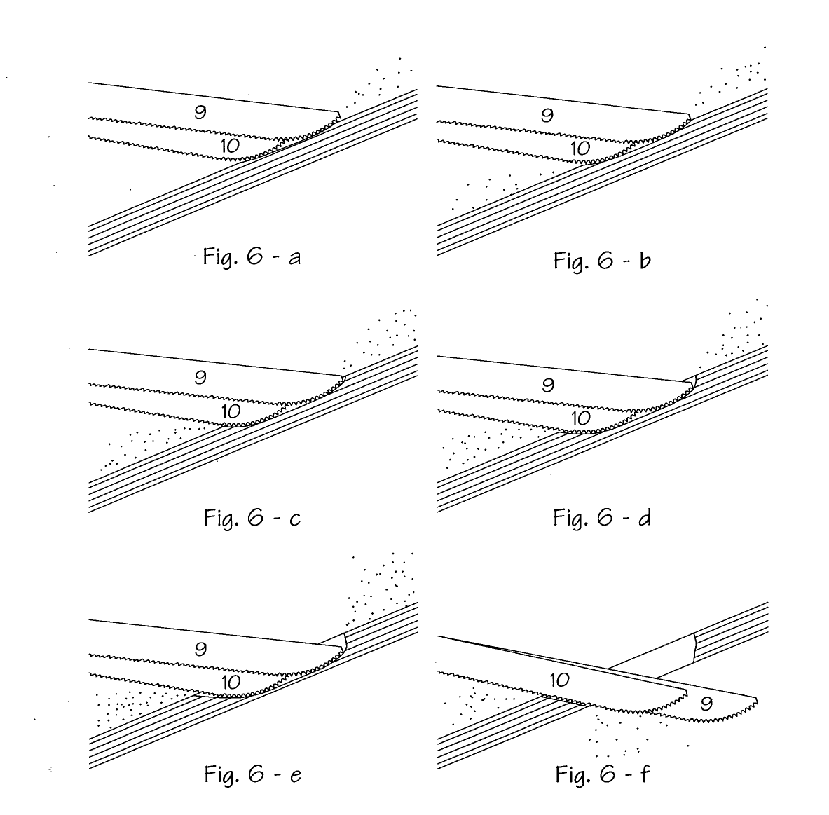

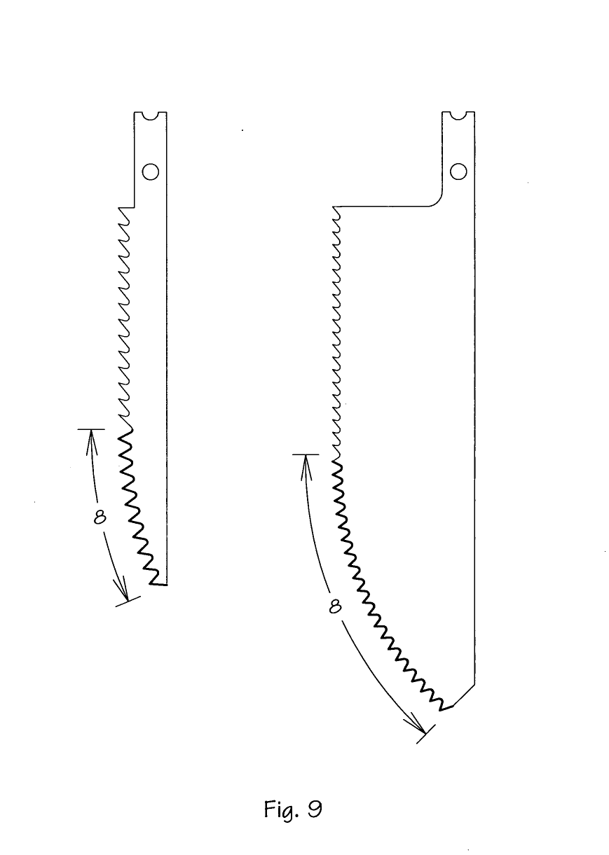

12. Instead of coming to a sharp point on the end of the sawing plane, the present invention's tip is at the end of the edge opposite the cutting edge, arching up to meet it FIGS. 4, 5 Ref. 8. The edge of the radial arch of the tip may have either various TPI (teeth per inch) which may be straight, staggered or angled in an alternating pattern FIG. 5 or an abrasive coating grit FIG. 8 depending on the material to be cut and the desired finish. The improved tip begins to cut the surface immediately upon impact FIG. 6a to f and does not need to originate its cut from an outside edge of the material before engaging the sawing edge; it saws at any internal point, maximizing the forward and backstrokes of the reciprocating action Ref. 9, 10.

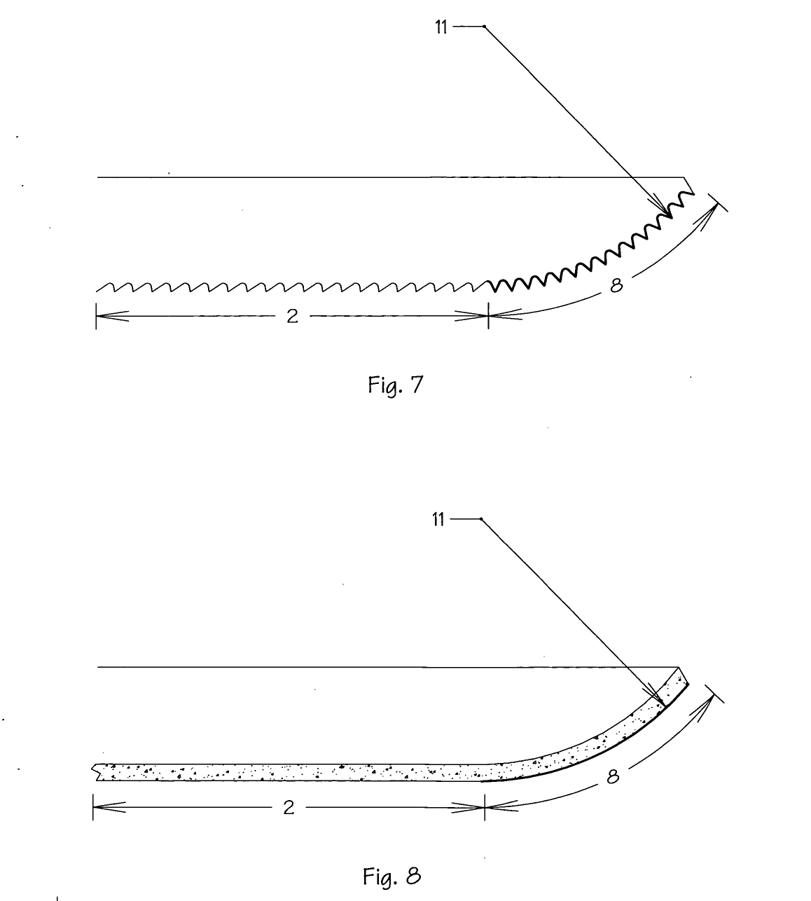

13. In the event TPI are used FIG. 7, the cutting tip of each tooth is the end point of the radius extension Ref. 11 perpendicular to the tangents on the arch of the circle the radius creates. Each radius-extension point has a dual cutting edge equiangular on both sides of the radius vector angled away from the point and toward the arch. The radial arch may also have a smooth edge with an abrasive diamond or carbide grit coating for cleaner finishes, its sawing edge also created from the radius extension from the center point of the radius. An adaptation of the arch of the improved tip design may include, but is not limited to, adjusting the arch on any type of blade to produce fastcuts or flushcuts FIGS. 8,9.

1. (canceled)

2. A reciprocating saw blade for creating a cut penetrating a working surface of various thicknesses and hardness at an interior point independent of the working surface's exterior edges, said blade having a cutting edge and a non-cutting opposite edge.

3. A blade in claim 1 wherein said cutting edge and said non-cutting opposite edge extend away from the end that attaches to the saw, the cutting edge curving upward and converging with the non-cutting opposite edge, creating an arched/radial tip.

4. A blade in claim 1 wherein said arched/radial tip's cutting edge has either various TPI (teeth per inch) or an abrasive grit coating, depending on the hardness of the working surface to be cut.

5. A tooth in claim 3 wherein each tooth on the arched/radial tip's cutting edge is immediately adjacent to the other with not space in between.

6. A tooth in claim 3 wherein the point of said tooth on the arched/radial tip's cutting edge is the end point of the radius extending to a specified distance beyond the arch it creates and said radius extension is perpendicular to the tangents on said arch.

7. A tooth in claim 5 wherein each tooth is equiangular on both sides of said radius extension, angling away from its point and toward the arch a dual-cutting edge and.

8. A tooth in claim 3 wherein the point of said tooth on the cutting edge of the arched/radial is the intersection of the radius extension and the extension of said equiangular sides of the tooth.
